(19) United States
(12) Patent Application Publication
(10) Pub. No.: US 2003/0083856 A1
(43) Pub. Date: May 1, 2003

(54) Model analyzing method and apparatus, and storage medium

(75) Inventors: Tatsuro Yoshimura, Kawasaki (JP); Shigeo Sakamoto, Kawasaki (JP); Atsushi Serizawa, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/103,893

(22) Filed: Mar. 25, 2002

(30) Foreign Application Priority Data
Oct. 31, 2001 (JP) 2001-335416

(51) Int. Cl. G06F 17/50

(52) U.S. Cl. 703/18

(57) ABSTRACT

In a model analyzing method for analyzing power supply noise of a current model, a feedthrough current model is formed based on AC characteristics, a driver model is formed based on DC characteristics and AC characteristics, a mesh model is formed, and the power supply noise is analyzed by arranging the feedthrough current model and the driver model in the mesh model.

### BACKGROUND OF THE INVENTION

This application claims the benefit of a Japanese Patent Application No. 2001-335416 filed Oct. 31, 2001 in the Japanese Patent Office, the disclosure of which is hereby incorporated by reference.

1. Field of the Invention

The present invention generally relates to model analyzing methods and apparatuses, and storage media, and more particularly to a model analyzing method and apparatus suitable for analyzing power supply noise by creating a circuit analyzing model, and a computer-readable storage medium which stores a computer program for causing a computer to execute such a model analyzing method.

2. Description of the Related Art

In simulating transmission signals in a printed circuit board, the power supply of an element mounted on the printed circuit board is usually analyzed with the assumption that it is an ideal power supply. However, as the number of gates of the element increases, the power consumption increases and thus the effects on the fluctuation of the power supply voltage and on the output level become non-negligible.

Accurate effects on the fluctuation of the power supply and on the output level can be analyzed by using an accurate transistor model of each element, but such accurate transistor model is very difficult to acquire. Furthermore, considering the time required to analyze the element made up of several ten thousands of gates, such an analysis is not practical.

Therefore, as a first requirement, it is desirable to realize a simulation technique in which the effects on the fluctuation of power supply voltage and on the output level due to the operation of the elements are considered.

On the other hand, a propagation waveform simulation of high precision is necessary in order to design a printed circuit board that poses no problem to the signal transmission in wiring patterns on the printed circuit board. In the propagation waveform simulation, a driver model constituting a signal generating source is required and thus it is necessary to obtain the driver model from the device manufacturer. There are mainly two types of driver models. One is the IBIS (Input/output Buffer Information Specification) model, and the other is the SPICE (Simulation Program with Integrated Circuit Emphasis) model.

The IBIS model treats an IC package as a black box and indicates the DC characteristics/AC characteristics of the output as numerical data. Thus, there is no risk of design know-how being revealed. For this reason, the IBIS model is available from most device manufacturers. However, because the AC characteristics of the IBIS model have fixed values, it is not possible to accurately analyze the change in AC characteristics with respect to a change in the load. Furthermore, since the IBIS model is formed on the assumption that power supply does not fluctuate, the change in the output level with respect to the fluctuation of the power supply cannot be expressed. Therefore, the accuracy of the propagation waveform simulation using the IBIS model is very poor.

On the other hand, the SPICE model is a transistor model describing the design data itself of the driver circuit. Thus, by using the SPICE model for analysis, a result very close to the actual measurement can be obtained, and no problem will arise as in the case where the IBIS model is used. Therefore, the accuracy of the propagation waveform simulation obtained using the SPICE model is very high. However, supplying the SPICE model will also mean supplying the design know-how, and thus most device manufacturers do not supply the SPICE model. Thus, it is very difficult to acquire the SPICE model.

For this reason, as a second requirement, it is desirable to improve the accuracy of the propagation waveform simulation by forming the SPICE model based on the IBIS model available from the device manufacturers, and performing the propagation waveform simulation based on this SPICE model.

Furthermore, a circuit analyzing model used by a circuit analyzing program which uses the SPICE model to simulate circuit operations and electrical properties of the transmission paths such as power supply/ground layers, and signal lines of a printed circuit board, a multi chip module (MCM), and the like, is conventionally formed by a ladder which is made up of, inductors, capacitors, and resistors. Although it is preferable to reduce the sectioning pitch of the ladder circuit in order to maintain analyzing accuracy, as the sectioning pitch becomes smaller, the number of elements increases inversely proportional to the sectioning pitch, and thus the analyzing time becomes longer.

Thus, as a third requirement, it is desirable to realize a circuit analyzing model capable of increasing the sectioning pitch of the ladder circuit and suppressing the increase in the number of elements, that is, suppressing the increase in the analyzing time, without deteriorating the analyzing accuracy.

As described above, as the first requirement, it is desirable to realize a simulation method in which the effects on the fluctuation of power supply voltage and on the output level due to the operations of the elements are considered.

Furthermore, as a second requirement, it is desirable to improve the accuracy of the propagation waveform simulation by forming the SPICE model based on the IBIS model available from the device manufacturers and performing the propagation waveform simulation based on this SPICE model.

Furthermore, as a third requirement, it is desirable to realize a circuit analyzing model capable of increasing the sectioning pitch of the ladder circuit and suppressing the increase in the number of elements and hence suppressing the increase in the analyzing time, without deteriorating the analyzing accuracy.

### SUMMARY OF THE INVENTION

Accordingly, it is a general object of the present invention to provide a model analyzing method and apparatus and a storage medium that satisfy at least one of the three requirements described above.

Another and more specific object of the present invention is to provide a model analyzing method for analyzing the power supply noise of a circuit model, having steps of forming, based on AC characteristics, a feedthrough current model for simulation using, as a base model, a CMOS structure having one or more stages using a non-linear element, and analyzing the power supply noise based on at least the feedthrough current model. According to the present invention, the first requirement can be met.

Still another object of the present invention is to provide a model analyzing method for analyzing the power supply noise of a circuit model, having steps of forming, based on DC characteristics and AC characteristics, a driver model for simulation using, as a base model, a CMOS structure having one or more stages using a non-linear element, and analyzing the power supply noise based on at least the driver model. According to the present invention, the second requirement can be met.

A further object of the present invention is to provide a model analyzing method for analyzing power supply noise of a circuit model, having the steps of forming a mesh model by calculating the sectioning pitch P0 of a location where an element constituting the wave source is connected as a function of a rise time tr and a fall time tf of the waveform from the wave source, and setting a sectioning pitch P1 at a location as this location moves further away from the wave source to a value less than or equal to a value that is calculated by a function of the sectioning pitch P0, an area S0 of the location where the wave source is connected, and an area S1 to the location moved further away from the wave source; and analyzing the power supply noise at least based on the mesh model. According to the present invention, the third requirement can be met.

Another object of the present invention is to provide a model analyzing method for analyzing the power supply noise of a circuit model having the steps of forming, based on AC characteristics, a feedthrough current model for simulation using, as a base model, a CMOS structure having one or more stages using a non-linear element, forming, based on DC characteristics and AC characteristics a driver model for simulation using, as a base model, a CMOS structure having one or more stages using a non-linear element as a base, forming a mesh model for simulation, and analyzing the power supply noise by arranging the feedthrough current model and the driver model in the mesh model. According to the present invention, the above first and second requirements can be met.

In this case, the step of forming the mesh model may calculate the sectioning pitch P0 of the location where the element constituting the wave source is connected as a function of a rise time tr and a fall time tf of the waveform from the wave source, and set the sectioning pitch P1 at a location as this location moves further away from the wave source to a value less than or equal to a value that is calculated by a function of the sectioning pitch P0, an area S0 of the location where the wave source is connected, and an area S1 to the location moved further away from the wave source, so as to create the mesh model. Thus, the third requirement can be met.

Still another object of the present invention is to provide a computer-readable storage medium for storing a computer program including procedures for the computer to execute the steps of any of the above model analyzing methods.

A further object of the present invention is to provide a model analyzing apparatus for analyzing a power supply noise of a circuit model having means for forming, based on AC characteristics, a feedthrough current model for simulation using, as a base model, a CMOS structure having one or more stages using a non-linear element; means for forming, based on DC characteristics and AC characteristics, a driver model for simulation using, as a base model, a CMOS structure having one or more stages using a non-linear element; means for forming a mesh model for simulation; and means for analyzing the power supply noise by arranging the feedthrough current model and the driver model in the mesh model. According to the present invention, the first and second requirements can be met.

In this case, the means for forming the mesh model may calculate the sectioning pitch P0 of the location where the element constituting the wave source is connected as a function of a rise time tr and a fall time tf of the waveform from the wave source, and set the sectioning pitch P1 at a location as this location moves further away from the wave source to a value less than or equal to a value that is calculated by a function of the sectioning pitch P0, an area S0 of the location where the wave source is connected, and an area S1 to the location moved further away from the wave source, so as to create the mesh model. Thus, the third requirement can be met.

Other objects and further features of the present invention may be apparent from the following detailed description when read in conjunction with the accompanying drawings.

### BRIEF DESCRIPTION OF THE DRAWINGS

FIG. 1 is a diagram explaining paths of currents;

FIG. 2 is a diagram explaining a combination of a driver model, a feedthrough current model, and a mesh model;

FIG. 3 is a perspective view showing a computer system to which the present invention is applied;

FIG. 4 is a block diagram explaining a construction of an important part within a main body of the computer system;

FIG. 5 is a flow chart explaining a power supply noise analyzing process;

FIG. 6 is a diagram showing a feedthrough current;

FIG. 7 is a simplified view of internal gates of an element;

FIG. 8 is a circuit diagram showing a feedthrough current model;

FIG. 9 is a circuit diagram of a driver model;

FIG. 10 is a diagram showing a correspondence table of an IBIS model and a driver model;

FIG. 11 is a diagram explaining a mesh model;

FIG. 12 is a diagram showing a current source layer and a ground layer, and an element on a printed circuit board;

FIG. 13 is a diagram showing a mesh model of a current source layer and a ground layer on the printed circuit board;

FIG. 14 is a diagram showing a relationship of tr and tf of a transmission waveform and a transmission distance;

FIG. 15 is a diagram showing virtual meshes and active elements;

FIG. 16 is a diagram explaining calculation of a pitch;

FIG. 17 is a diagram explaining assignment of nodes;

FIG. 18 is a diagram explaining a wraparound process;

FIG. 19 is a flow chart explaining a process executed by a CPU for forming the mesh model; and

FIG. 20 is a flow chart explaining the process executed by the CPU for forming the mesh model.

### DESCRIPTION OF THE PREFERRED EMBODIMENTS

Each embodiment of a model analyzing method and apparatus, and a storage medium according to the present invention will be explained with reference to the figures.

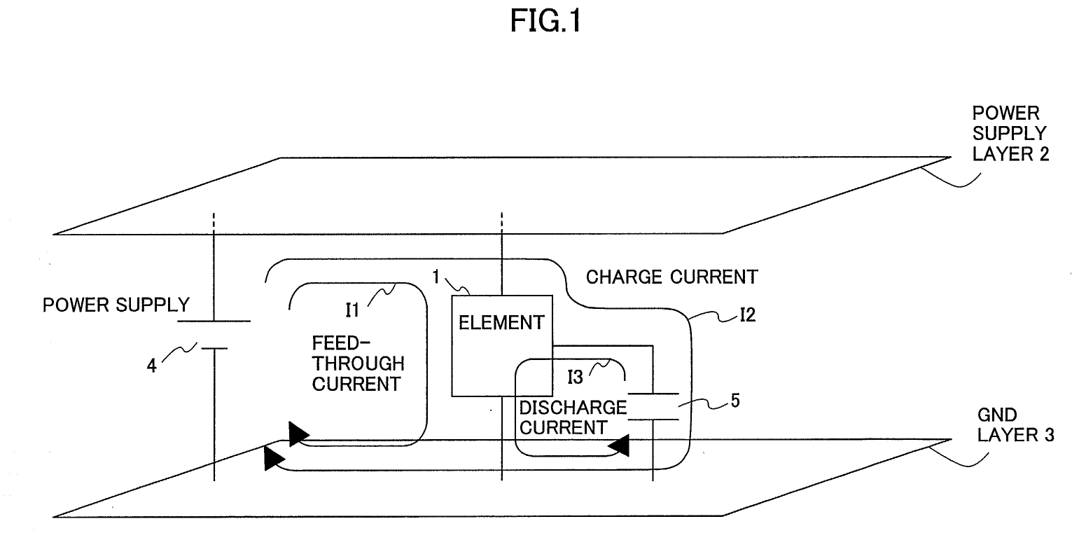

FIG. 1 is a diagram explaining paths of currents. The noise of a power supply system including power supply noise and ground noise generated when a feedthrough current I1 of an element 1 mounted on a printed circuit board, a charge current I2 and a discharge current I3 flow through a power supply (VDD) layer 2 and a ground (GND) layer 3, as shown in FIG. 1. In FIG. 1, a power supply and a capacitor are designated by reference numerals 4 and 5, respectively.

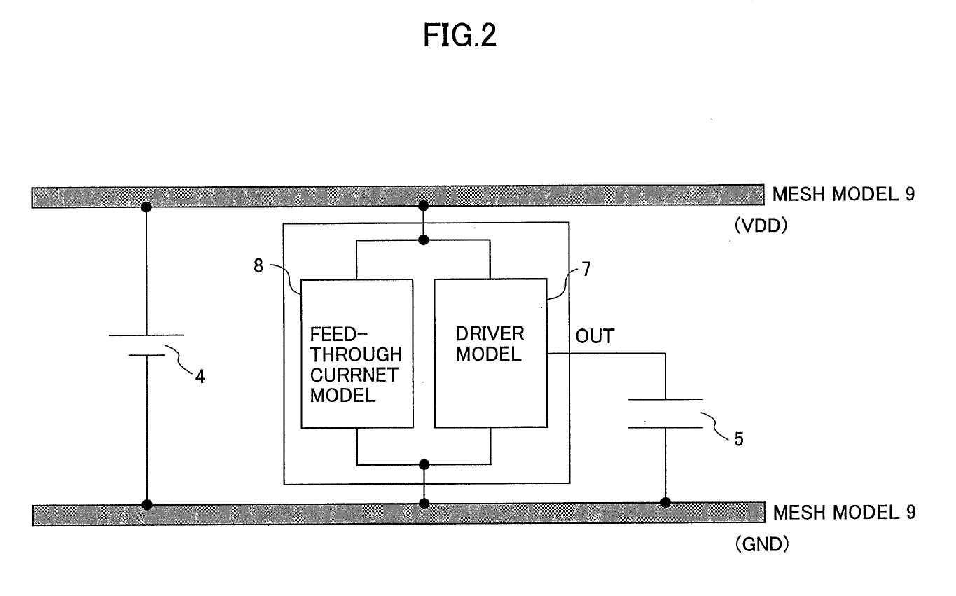

In other words, in order to analyze a noise model of the power supply system, a model for flowing the current and a model of a path through which the current flows are required. In an embodiment of the present invention described below, a driver model and a feedthrough current model are used as the noise model of the power supply system, and a mesh model is used as a model for flowing the current. The driver model, the feedthrough model, and the mesh model are used in combination, as shown in FIG. 2. FIG. 2 is a diagram explaining the combination of a driver model 7, a feedthrough current model 8 and a mesh model 9. In FIG. 2, those parts which are the same as those corresponding parts in FGI. 1 are designated by the same reference numbers, and a description thereof will be omitted.

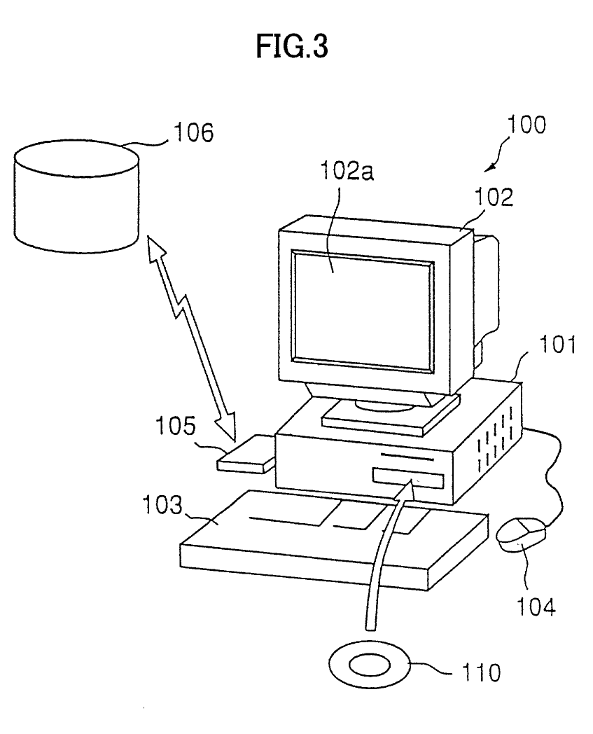

An embodiment of a model analyzing apparatus according to the present invention utilizes an embodiment of a model analyzing method according to the present invention, and an embodiment of a computer-readable storage medium according to the present invention. In this embodiment, the present invention is applied to a computer system. FIG. 3 is a perspective view of a computer system to which the present invention is applied in this embodiment.

A computer system 100 shown in FIG. 3 has a main body 101 provided with a CPU, a disk drive and the like, a display 102 for displaying an image on a display screen 102a in response to an instruction from the main body 101, a keyboard 103 for inputting various information to the computer system 100, a mouse 104 for specifying an arbitrary position on the display screen 102a of the display 102, and a modem 105 for accessing an external database or the like and downloading a computer program or the like stored in another computer system.

A computer program (model analyzing software), which causes the computer system 100 to have a model analyzing function is either stored in a portable recording medium such as a disk 110, or downloaded from a recording medium 106 of another computer system using a communication unit such as the modem 105, is input to the computer system 100 and compiled. The computer-readable storage medium according to the present invention is formed by a recording medium such as the disk 110, which stores the computer program. The recording medium forming the computer-readable storage medium according to the present invention is not limited to portable storage media such as the disk 100, IC card memory, floppy disk, magneto-optical disk and CD-ROM, and may be formed by any type of storage media accessible by a computer system, which is connected via a communication unit or communicating means such as the modem 105 or LAN.

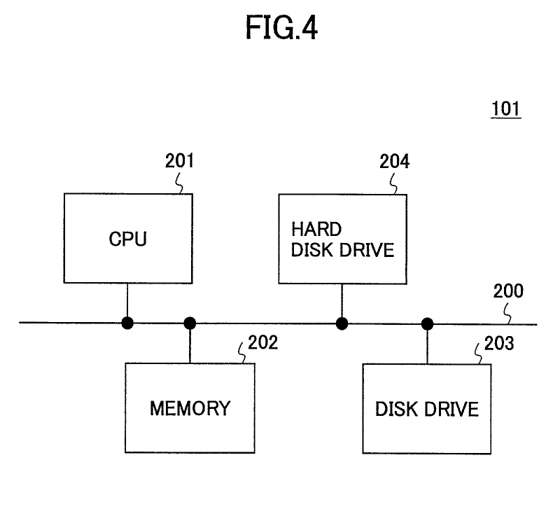

FIG. 4 is a block diagram explaining the construction of an important part within the main body 101 of the computer system 100. In FIG. 4, the main body 101 includes a CPU 201, a memory 202 made of a RAM, a ROM and the like, a disk drive 203 for the disk 110, and a hard disk drive 204 which are all connected through a bus 200. In this embodiment, although the display 102, the keyboard 103 and the mouse 104 are also connected to the CPU 201 via the bus 200, they may be directly connected to the CPU 201. Furthermore, the display 102 may be connected to the CPU 201 via a known graphic interface (not shown) for processing the input and output image data.

It is to be noted that construction of the computer system 100 is not limited to that shown in FIGS.3 and 4, and various constructions may be used as an alternative.

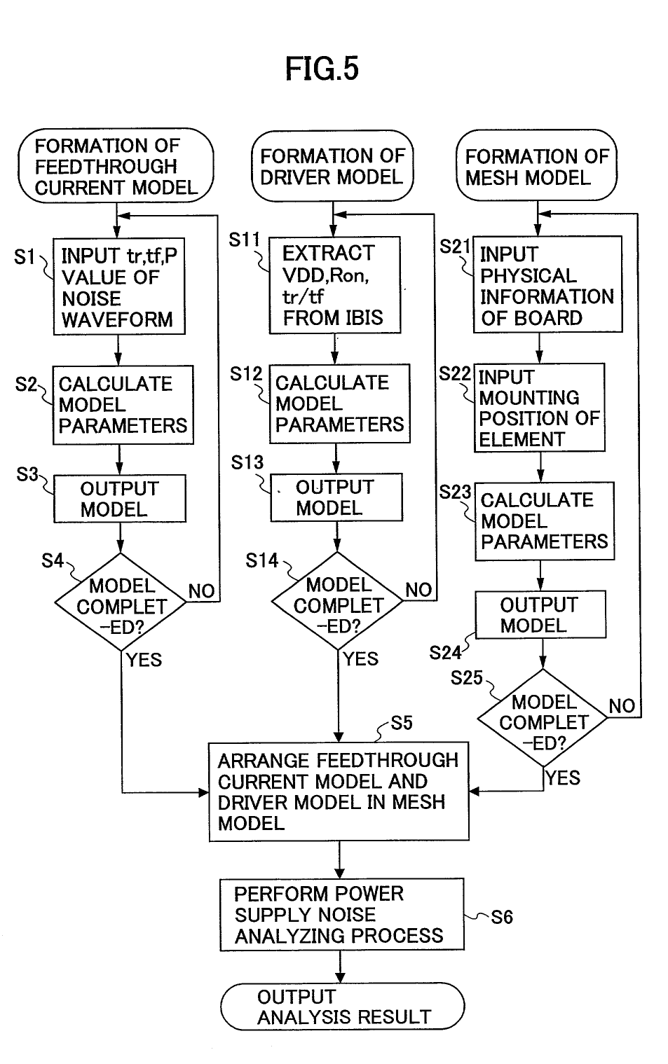

FIG. 5 is a flow chart explaining a power supply noise analyzing process of the CPU 201. In FIG. 5, the feedthrough current model 8 is formed by steps S1 through S4, the driver model 7 is formed by steps S11 through S14, and the mesh model 9 is formed by steps S21 through S25. In the steps S5 and S6, the power supply noise is analyzed using the feedthrough current model 8, the driver model 7, and the mesh model 9.

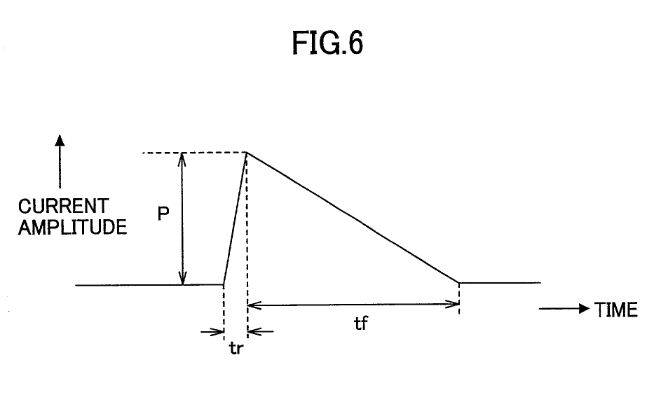

The feedthrough current I1 is a sum of a current flowing between the power supply layer 2 and the ground layer 3 as a result of p-channel and n-channel MOSFETs, forming the element 1 being turned ON simultaneously when the element 1 is switched, and a current flowing between the power supply and ground due to charge and discharge of a load within an LSI of the element 1. The feedthrough current model 8 is used to simply represent the feedthrough current I1. The feedthrough current model 8 represents the feedthrough current I1 by a triangular wave shown in FIG. 6, and a rise time tr, a fall time tf, and a peak value P of an amplitude can be set arbitrarily.

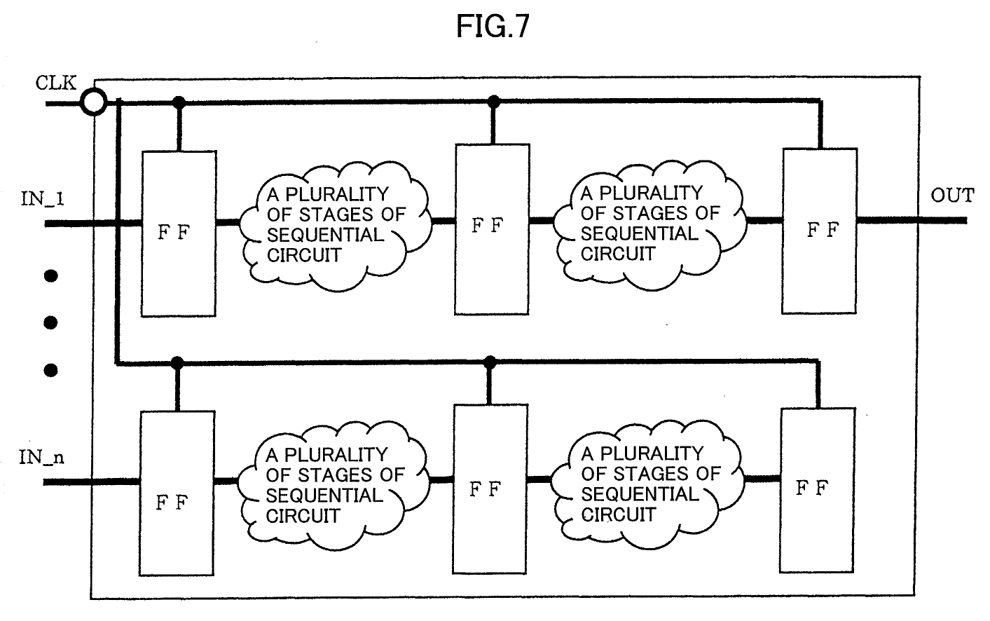

Next, a description will be given as to why the feedthrough current I1 is represented by the triangular wave shown in FIG. 6. FIG. 7 is a simplified view of internal gates of the element 1. First, the internal gates of the element 1 are simply represented by flip-flops (FF) indicated by a rectangular block and a plurality of stages of sequential circuits, as shown in FIG. 7. Since the internal gates are synchronized by a clock signal CLK, most circuit parts operate at the timing when the clock signal CLK is input, and the number of circuit parts, which operate decreases with lapse of time. As a result, when considering the internal gates as a whole, an output current waveform may be regarded as a triangular wave shown in FIG. 6. In FIG. 7, IN_1 through IN_n denote inputs, and OUT denotes an output.

Returning to the power noise analyzing process of FIG. 5, in step S1, the rise time tr, the fall time tf, and the peak value P of the amplitude for a case where the noise current has a current waveform shown in FIG. 6 are input. In step S2, parameters of the feedthrough current model 8 are calculated.

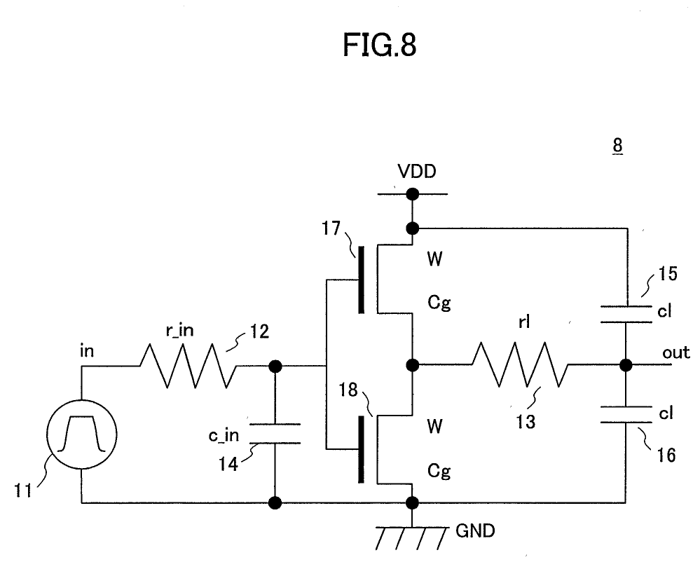

FIG. 8 is a circuit diagram of the feedthrough current model 8 used in this embodiment. The feedthrough current model 8 shown in FIG. 8 includes a current source 11, resistors 12 and 13, capacitors 14 through 16, and MOSFETs 17 and 18. The resistance value of the resistor 12 is r_in, and the resistance value of the resistor 13 is r1. In FIG. 8, “in” refers to the input and “out” refers to the output. The capacitance value of the capacitor 14 is c_in, and the capacitance values of the capacitors 15 and 16 are both c1. Furthermore, channel widths of the MOSFETs 17 and 18(CMOS) are both w, and a gate-source capacitances or a gate-drain capacitances of the MOSFETs 17 and 18 are both cg.

Of the parameters of the feedthrough current model 8, it is assumed that the rise time tr, the fall time tf and the peak value P of the amplitude of the current waveform of the input noise current generated by the current source 11, the capacitance value c_in of the capacitor 14, and the gate-source capacitance or the gate-drain capacitance cg of the MOSFETs 17 and 18 have fixed values. On the other hand, of the parameters of the feedthrough current model 8, it is assumed that a period of the input noise current generated by the current source 11, the resistance value r_in of the resistor 12, the resistance value r1 of the resistor 13, the capacitance value cl of the capacitors 15 and 16, and the channel width w of the MOSFETs 17 and 18 (CMOS) have variable values.

(1-1) The channel width w of the MOSFETs 17 and 18 (CMOS) can be obtained as follows. If the channel width w is changed under the condition that tf/tr is constant, the peak value P of the amplitude of the current waveform of the input noise current becomes larger as the channel width w becomes larger. This change in the peak value P cannot be formulated in a simple manner and thus the channel width w is determined from tf/tr and the peak value P using a table.

(1-2) The resistance value r1 of the resistor 13 can be obtained as follows. For each value of the channel width w, a formula P×tf/tr=a2×r1+2 stands between the resistance value r1 and P×tf/tr. Here, a2 and b2 are coefficients having different values depending on the channel width w. Accordingly, the coefficients a2 and b2 are determined based on the channel width w, and the resistance value r1 can be obtained.

(1-3) The resistance value r_in of the resistor 12 can be obtained as follows. The peak value P and tf/tr are constant with respect to a change in the resistance value r_in. However, assuming a3 is a coefficient, the rise time tr satisfies the formula tr=a3×r_in with respect to the change in the resistance value r_in. Thus, by arbitrarily choosing the resistance value r_in, it is possible to uniquely determine the rise time tr without changing the peak value P and the ratio tf/tr.

(1-4) The capacitance value c1 of the capacitors 15 and 16 can be obtained from a formula: c1=5×10⁻⁹×w×r_in.

(1-5) The period of the input noise current is determined depending on the model to be analyzed, that is, the operating period of the circuit.

By automating the above procedures (1-1) through (1-5), and forming a database of the coefficients a2, b2, and a3 in the above formulas, the parameters of the feedthrough current model 8 are calculated in step S2 based on the rise time tr, the fall time tf, and the peak value P of the amplitude of the current waveform of the noise current input in step S1 shown in FIG. 5. In step S3, the feedthrough current model 8 is output based on the calculated parameters. The database of the coefficients a2, b2, and a3 is storable in a storage means such as the hard disk drive 204 within the computer system 100 or a storage means within another computer system. In step S4, a decision is made as to whether the feedthrough current model 8 is completed or not, and if the decision result is NO, the process returns to step S1. On the other hand, if the decision result of step S4 is YES, the process proceeds to step S5 which will be described later.

Accordingly, in this embodiment, based on information on arbitrary AC characteristics, a current noise source model for simulation using a non-linear element, that is, the feedthrough current model using the CMOS structure having one or more stages such as that shown in FIG. 8 as a base model, is formed. The AC characteristics indicate the rise and fall times of the output current or the voltage waveform obtained when a certain current or voltage waveform is input. The AC characteristics of the current noise source may be determined from the device parameters of the CMOS and the passive element added to the device periphery. Furthermore, arbitrary AC characteristics and power supply voltage may be the input, and a current noise source model having properties that satisfy such inputs may be output. For the input power supply voltage, the coefficients of the appropriate calculation formulas may automatically be detected from the database, and the determination of the device parameters satisfying the input AC characteristics may be automated.

In this way, a simulation technique, which considers the effects on the fluctuation of the power supply voltage and on the output level due to the operation of the element 1 can be realized, and thus the first requirement previously mentioned can be satisfied. Furthermore, because the feedthrough current model 8 shown in FIG. 8 can be constructed from a one-stage CMOS gate and several passive elements, the analyzing time is very short. Moreover, since the current noise can be generated so as to respond to an input pulse, an analysis in the time domain becomes possible. Therefore, a a more accurate capacitance of the necessary bypass capacitor, estimates of the mounting position of each element, and a more accurate transmission waveform analysis in the printed circuit board can be performed.

The driver model 7 is formed to simply represent the electrical properties of the element 1 using the SPICE model of a standard CMOS. The original data used when forming the driver model 7 include a power supply voltage of the driver, the driving capacity, and the ratio tr/tf of the rise time tr and the fall time tf of the current waveform. These data are usually obtainable from the IBIS model. The IBIS model is available from the device manufacturer for most elements, and the driver model 7 can thus be formed from the IBIS model.

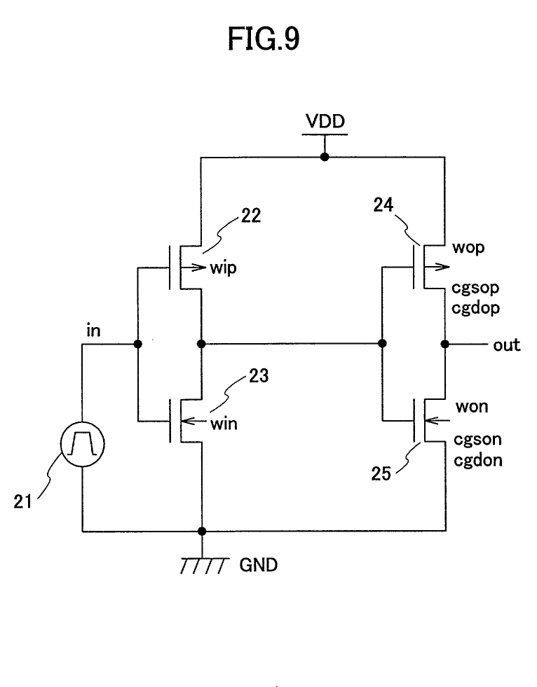

FIG. 9 is a circuit diagram of the driver model 7 used in this embodiment. The driver model 7 shown in FIG. 9 includes a current source 21, an input stage CMOS made of MOSFETs 22 and 23, and an output stage CMOS made of MOSFETs 24 and 25. In FIG. 9, “in” refers to the input and “out” refers to the output. The channel widths of the MOSFETs 22 and 23 are wip and win, respectively. Furthermore, the channel widths of the MOSFETs 24 and 25 are wop and won, respectively, the gate-source capacitances are cgsop and cgson, respectively, and the gate-drain capacitances are cgdop and cgdon, respectively. The channel widths wip and win of the MOSFETs 22 and 23 determine the DC characteristics, which are static characteristics of the MOSFETs 22 and 23. The channel widths wop and won of the MOSFETs 24 and 25 determine the AC characteristics of the MOSFETs 24 and 25. The gate-source capacitances cgsop and cgson and the gate-drain capacitances cgdop and cgdon of the MOSFETs 24 and 25 determine the AC characteristics of the MOSFETs 24 and 25. The AC characteristics indicate the rise and fall times of the output current or the voltage waveform obtained when a certain current or voltage waveform is input. Channel lengths L2 through L5 of the MOSFETs 22 through 25 are included in the parameters of the driver model 7 in addition to those above, but a description thereof will be omitted since they may respectively be set to the same fixed value depending on the power supply voltage VDD.

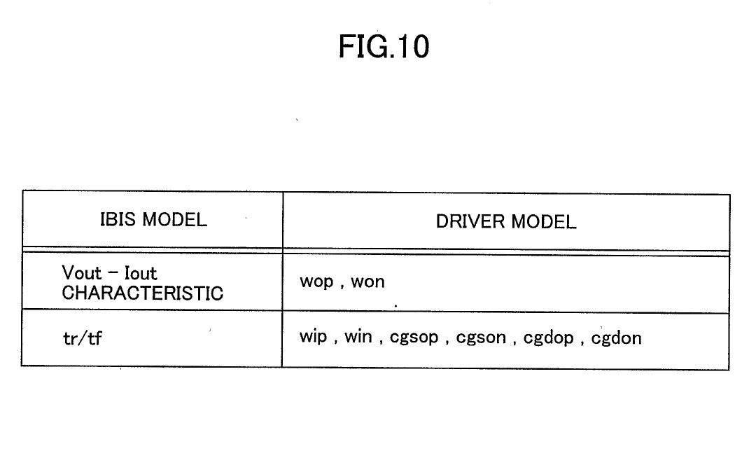

FIG. 10 shows a correspondence table of the parameters of the IBIS model and the driver model 7. Using the correspondence table shown in FIG. 10, the channel widths wop and won of the MOSFETs 24 and 25 of the driver model 7 are determined from the output voltage-output current (Vout-Iout) characteristic of the IBIS model. Furthermore, the channel widths wip and win of the MOSFETs 22 and 23 of the driver model 7, the gate-source capacitances cgsop and cgson and the gate-drain capacitances cgdop and cgdon of the MOSFETs 24 and 25 are determined from the ratio tr/tf of the IBIS model.

Returning to the power supply noise analyzing process shown in FIG. 5, in step S11, the power supply voltage VDD, an ON-resistance Ron of the IBIS model, and the ratio tr/tf of the rise time tr and the fall time tf of the current waveform are extracted from the IBIS model. In step S12, the parameters of the driver model 7 are calculated using the correspondence table shown in FIG. 10.

Each parameter determining the DC characteristics and the AC characteristics of the driver model 7 is uniquely determined based on the ON-resistance Ron of the IBIS model and the ratio tr/tf of the rise time tr and the fall time tf of the current waveform. More specifically, if wop=won=wo, wip=win=wi, and cgsop=cgson=cgdop=cgdon=cg, the parameters wo, wi, and cg can be calculated from the following formulas (1) through (3), where d1 through d4 denote coefficients respectively having a unique value with respect to the power supply voltage VDD.

wo=d1/Ron (1)

wi=d2×wo (2)

cg=(tr/tf−d3)/d4 (3)

(2-1) The power supply voltage VDD is read from [Voltage Range] of the IBIS model, and the coefficients d1 through d4 of the above formulas (1) through (3) are determined.

(2-2) The ON-resistance Ron is read from [Pull Up] and [Pull Down] of the IBIS model. The ON-resistance Ron is the slope of the voltage-current curve near the operating point of the circuit.

(2-3) The channel width wo of the MOSFETs 24 and 25 is calculated using the above formula (1).

(2-4) The channel width wi of the MOSFETs 22 and 23 is calculated from the channel width wo of the MOSFETs 24 and 25 using the above formula (2).

(2-5) The ratio tr/tf of the rise time tr and the fall time tf of the current waveform is read out from [Ramp] of the IBIS model.

(2-6) The gate-source capacitance cg or the gate-drain capacitance cg of the MOSFETs 22 through 25 is calculated using the above formula (3).

(2-7) The SPICE model is formed using the circuit shown in FIG. 9 as a base model.

In step S12, by automating the above procedures (2-1) through (2-7) and forming a database of the coefficients d1 through d7 in the above formulas, the parameters of the driver model 7 are calculated based on the power supply voltage VDD, the ON-resistance Ron of the IBIS model, the ratio tr/tf of the rise time tr and the fall time tf of the current waveform which are extracted in step S11 shown in FIG. 5. In step S13, the driver model 7 is output based on the calculated parameters. The database of the coefficients d1 through d4 is storable in a storage means such as the hard disk drive 204 within the computer system 100 or a storage means within another computer system. In step S14, a decision is made as to whether the driver model 7 is completed or not, and if the decision result is NO, the process returns to step S11. On the other hand, if the decision result of step S14 is YES, the process proceeds to step S5 which will be described later.

There are cases other than when forming the SPICE model from the IBIS model, where it is necessary to form the SPICE model having arbitrary characteristics in circuit simulation. In these cases, the SPICE model can be easily formed by processes described above. Furthermore, when it is desired to form the SPICE model having arbitrary characteristics, the power supply voltage VDD, the ON-resistance Ron and the ratio tr/tf are appropriately determined in the procedures (2-1), (2-2), and (2-5).

Therefore, in this embodiment, based on the information on arbitrary DC characteristics and AC characteristics, a simple driver model for simulation using the non-linear element, that is, a driver model formed using, as a base model, a two-stage CMOS structure formed by 4 MOSFETs as shown in FIG. 9 or a one-stage CMOS structure formed by 2 MOSFETs is formed. The DC characteristics of the driver output can be determined by controlling the device parameters of the CMOS, and the AC characteristics of the driver output can be determined by controlling the device parameters of the CMOS. The relationship between the channel width when the channel length of the final-stage CMOS is fixed, and the output resistance of the driver can be defined by the above formula (1). The relationship between the channel width when the channel length of the CMOS at the stage before the final-stage CMOS is fixed, and the channel width of the final-stage CMOS can be defined by the above formula (2). Furthermore, the relationship between the parasitic capacitance of the final-stage CMOS and the rise time/fall time of the driver output can be defined by the above formula (3).

The channel length of the CMOS in all stages may be determined depending on the value of the power supply voltage. The characteristics of the driver model may be determined based on the data related to DC characteristics, the data related to AC characteristics, and the data related to power supply voltage of the IBIS model. Furthermore, the parameters can easily be determined from the electrical properties by tabulating the coefficients of the above formulas (1) through (3) depending on the power supply voltage.

It is also possible to output a driver model having characteristics which satisfy the input information, by inputting desired arbitrary DC characteristics, AC characteristics, and power supply voltage. It is also possible to automatically detect from the database, the coefficients of the appropriate calculating formulas with respect to the input power supply voltage. Furthermore, the determination of the device parameters satisfying the input DC characteristics and the determination of the device parameter satisfying the input AC characteristics may be automated. A function of automatically extracting the data necessary for forming the driver model from the IBIS model and using the data as the initial condition when forming the driver model may be provided.

In this way, the SPICE model can be formed based on the IBIS model available from the device manufacturer. Performing the propagation waveform simulation based on such SPICE model can improve the accuracy of the propagation waveform simulation. The second requirement previously mentioned can thus be satisfied.

The feedthrough current I1, the charge current I2, and the discharge current I3 generated by the operation of element 1 flow to the power supply layer 2 and the ground layer 3. As the currents pass through these layers 2 and 3, a potential difference occurs at various points on the printed circuit board since the power supply layer 2 and the ground layer 3 have impedances. By sectioning the printed circuit board into meshes and modeling the impedance between the meshes, a mesh model 9 can be formed.

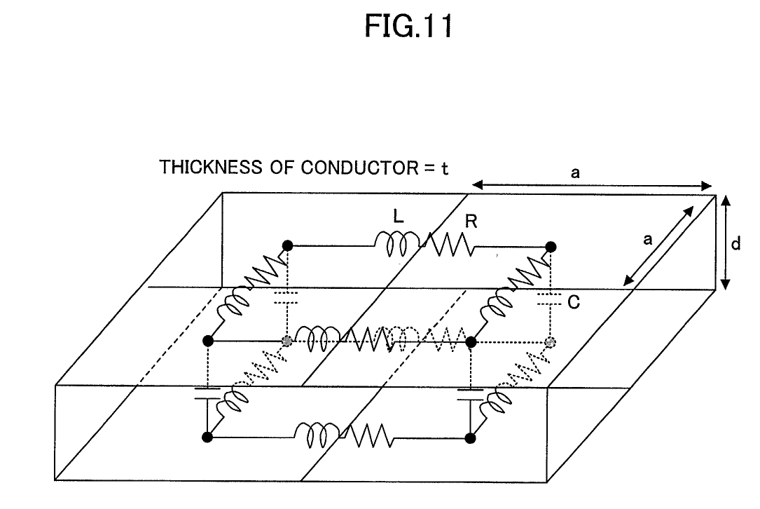

FIG. 11 is a diagram explaining the mesh model 9. In FIG. 11, R denotes a resistor, L denotes an inductor, C denotes a capacitor, a denotes a square mesh sectioning width (hereinafter referred to as a sectioning pitch), d denotes a thickness of the printed circuit board, and t denotes a thickness of a conductor on the printed circuit board. If σ denotes resistivity, μ denotes magnetic permeability, and ∈ denotes dielectric constant, the resistance value of the resistor R can be described by R=σ/t, the inductance of the inductor L by L=μd, and the capacitance of the capacitor C by C=(∈a²)/d.

In order to accurately express the power supply noise generated in the power supply layer 2 and the ground layer 3, the sectioning pitch of the mesh must be smaller than the sectioning pitch which is determined by the frequency components included in the power supply noise. However, when the entire printed circuit board is sectioned with such a sectioning pitch, the size of the mesh model 9 becomes extremely large and the analyzing time becomes extremely long. Thus, in this embodiment, as will be described hereinafter, the sectioning pitch of the meshes is reduced near the element 1 and wide increased at other parts, so that it is possible to realize a circuit analyzing model capable of increasing the sectioning pitch of the ladder circuit without deteriorating the analyzing accuracy and suppressing the increase of the number of elements, that is, suppressing the increase of the analyzing time. The third requirement previously explained can thus be satisfied.

Returning to the power supply noise analyzing process shown in FIG. 5, in step S21, physical information of the printed circuit board is input, and in step S22, the mounting position of the element 1 on the printed circuit board is input. In step S23, the parameters of the mesh model 9 are calculated, and in step S24, the mesh model 9 is output based on the calculated parameters. In step S25, a decision is made as to whether the mesh model 9 is completed or not, and if the decision result is NO, the process returns to step S21. On the other hand, if the decision result of step S25 is YES, the process proceeds to the subsequent step S5.

In step S5, a circuit analyzing model is formed by appropriately arranging the feedthrough model 8 and the driver model 7 in the mesh model 9 which is formed as described above. In step S6, the power supply noise analyzing process is performed using the circuit analyzing model, and the process ends to output the analysis result by a known mean. More specifically, the analysis result is displayed on the display screen 102a of the display 102. Thus, the power supply noise generated in the power supply layer 2 and the ground layer 3 can be analyzed in a short time and with a high accuracy.

Next, of the power supply noise analyzing process shown in FIG. 5, the process of steps S21 through S25, which form the mesh model 9 will be described in more detail. In this embodiment, the sectioning pitch of the ladder circuit formed by inductors, capacitors and resistors and the like is optimized when forming a circuit analyzing model of the transmission path such as the power supply layer, the ground layer and the signal line of the printed circuit board, MCM or the like by the following procedures ST1 through ST15.

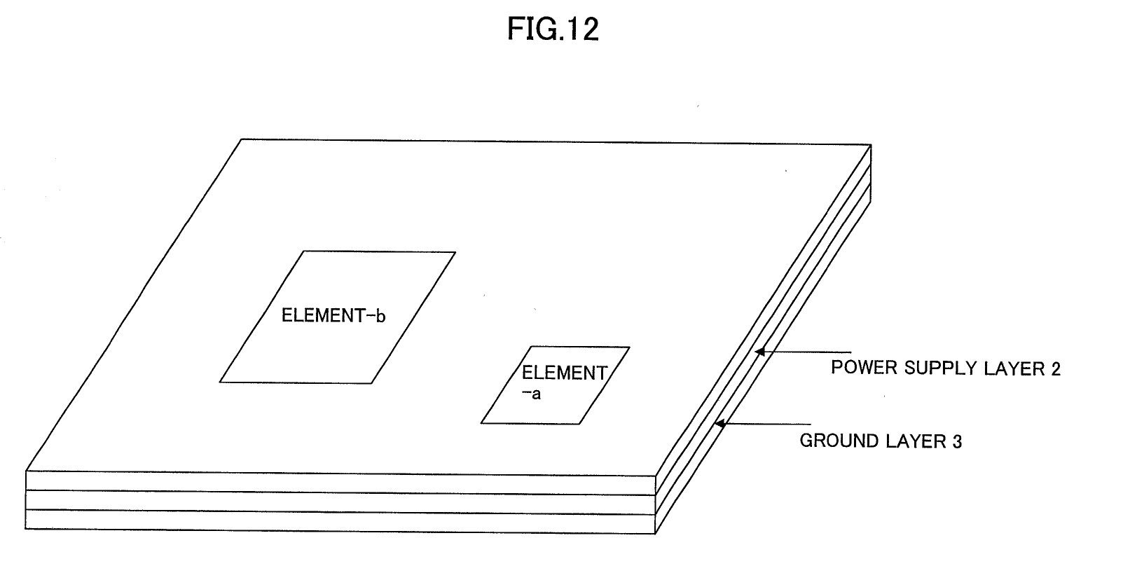

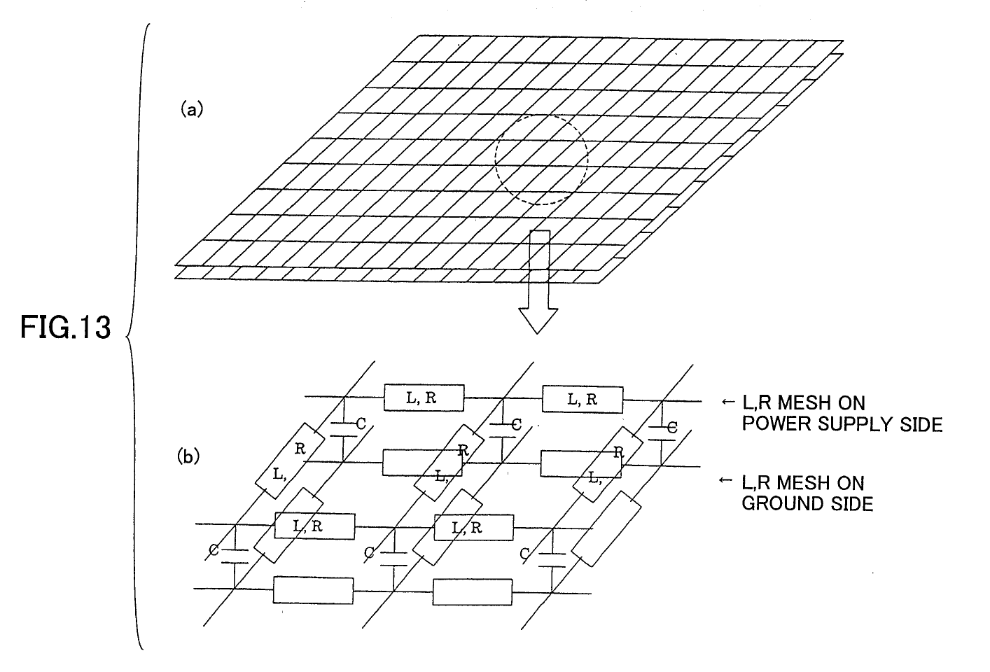

FIG. 12 is a diagram showing the power supply layer 2, the ground layer 3, and the elements 1 (a,b) on the printed circuit board. FIG. 13 is a diagram showing the mesh model 9 of the power supply layer 2 and the ground layer 3 on the printed circuit board. In FIG. 13, (a) shows the meshes of the power supply layer 2 and the ground layer 3, and (b) shows a circuit diagram of an important part of the meshes shown in (a). In FIG. 13, L denotes an inductor, C denotes a capacitor, and R denotes a resistor.

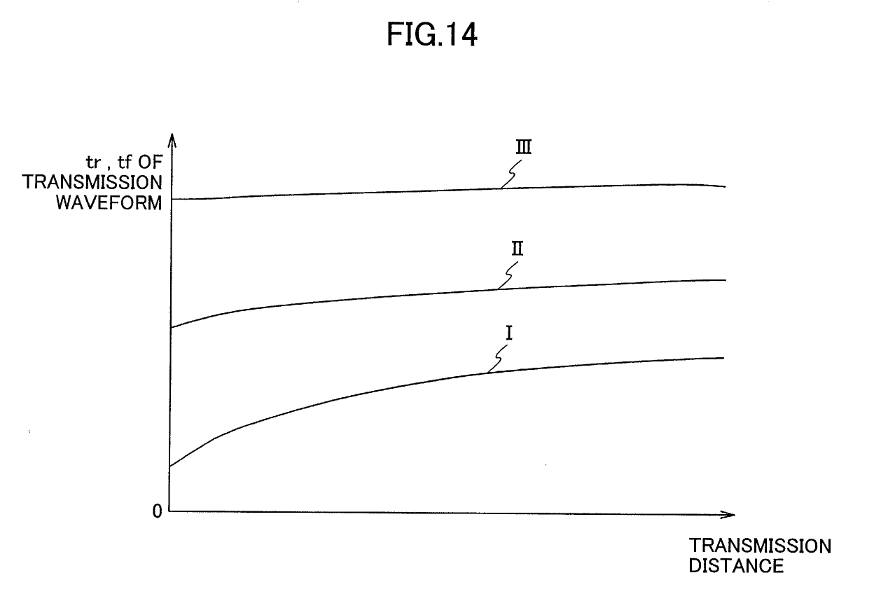

When a signal waveform is propagated through the transmission path, the signal waveform is distorted with propagation due to the resistance component, skin effect, dielectric loss and the like. Using this characteristic, the sectioning pitch of the ladder circuit is determined by predicting the degree of distortion at certain locations on the transmission path in advance. FIG. 14 is a diagram showing the relationship of tr and tf of the transmission waveform and a transmission distance. In FIG. 14, the ordinate indicates tr and tf of the transmission waveform, and the abscissa indicates the transmission distance. In FIG. 14, in case I, the rise time tr and the fall time tf of the input waveform are short, and the waveform of the transmission path is quickly distorted. In case III, the rise time tr and the fall time tf of the input waveform are long, and the degree of distortion of the waveform of the transmission path is slow. Case II shows a situation in between cases I and III.

The determination the mesh model 9 for a pair of the power supply layer 2 and the ground layer 3 (hereinafter simply referred to as V/G pair), that is, the sectioning pitch of the ladder model will now be described.

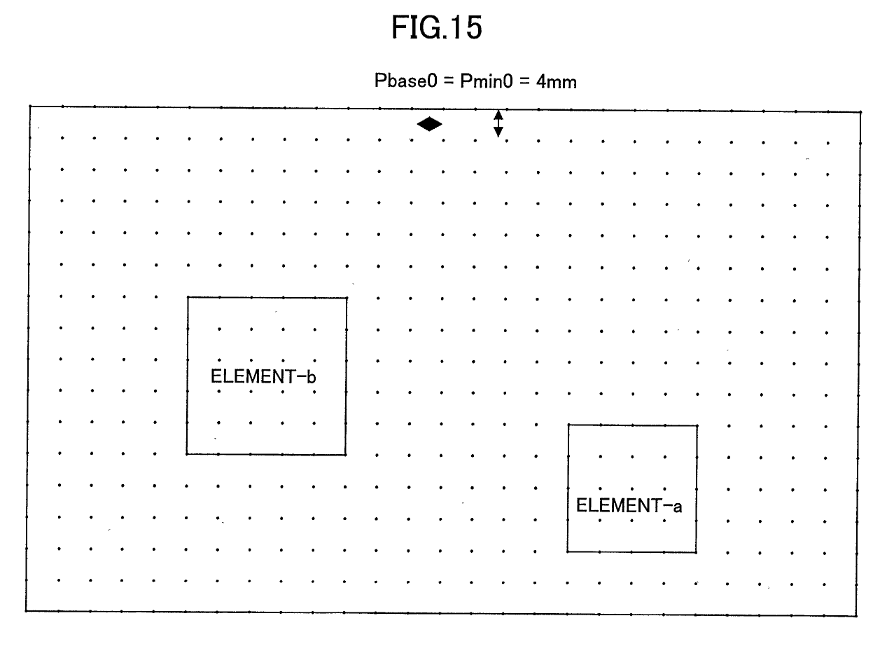

ST1: Of pitches Pmin-x determined from tr and tf of the active elements x connected to the V/G pair, a minimum pitch Pmin(0) is used to form virtual meshes. This pitch is set to Pbase0 (=Pmin(0)). FIG. 15 is a diagram showing the virtual meshes and the active elements, and the active elements a and b are represented by a square indicated by a solid line. If Pmin-a (Pmin of the active element a) is 4 mm and Pmin-b (Pmin of the active element b) is 6 mm, then Pbase0=Pmin0=4 mm in FIG. 15.

ST2: A V/G terminal or a terminal area of the active element is assigned to the virtual meshes.

ST3: A pitch Pmin-a(1) of an area extended by 1Pbase0 from the terminal or the terminal area of the element-a on the right side having the smallest pitch Pmin, is obtained from the following formula. Here, S(0) denotes the area of the terminal area of the element-a before the extension, and S(1) denotes the area of the area after the extension by 1Pbase0.

Pmin-a(1)=√(Pmin-a(0)²+kd×(√S(1)−√S(0)))[unit: mm,mm²]

Pmin-x(n)=√(Pmin-x(n−1)²+kd×(√S(n)−√S(n−1))) stands as a general formula, where kd denotes a coefficient corresponding to the material of the printed board. The same process is carried out simultaneously with respect to areas with the same pitch Pmin.

ST4: If the area connects to an area of another element when extended, the combined area is considered as one new area, and the smaller of the two pitches Pmin is considered as the pitch Pmin of this new area.

ST5: The pitch Pmin-a(1) is compared with the pitch Pmin of another element, and the element with the smallest pitch Pmin is selected.

ST6: For the selected element, the pitch Pmin(n+1)of the area extended by 1Pbase0 from the area having the pitch Pmin(n) is obtained from the same formula described above in a similar manner as in procedure ST3.

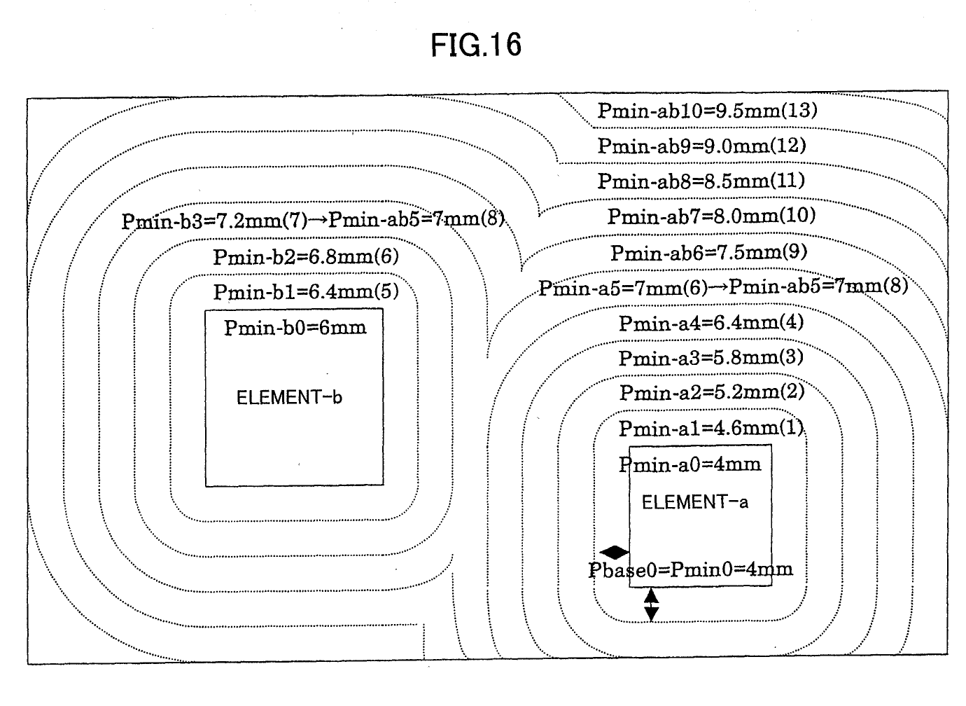

ST7: The above procedures ST4, ST5, and ST6 are similarly repeated until the pitch Pmin(n) is defined with respect to all of the areas. FIG. 16 is a diagram showing the calculation of the above pitch. In FIG. 16, the numbers in brackets represent the order of calculation.

ST8: All nodes of the virtual meshes of the procedure ST1 are considered as nodes of base0.

ST9: Of the nodes in the procedure ST8, every other staggered nodes are considered as nodes of base1. Thus, half of the nodes of base0 become nodes of base1.

ST10: Of the nodes in the above procedure ST9, every other staggered nodes are considered as nodes of base2. Thus, half of the nodes of base1 become nodes of base2.

ST11: Similarly thereafter, of the nodes of base(n), every other staggered nodes are considered as nodes of base(n+1). As a result, half of the nodes of base(0) become nodes of base(n+1). Such a process is continued until the number of nodes becomes one.

ST12: It is regarded that Pbase1=Pbase0×√2, Pbase2=Pbase1×√2, . . . , Pbase(n)=Pbase(n−1)×√2.

ST13: For each pitch Pmin(n) defined in the procedure ST7, the size relationship is compared with respect to Pbase(n), and the nodes of base0 or more are assigned to regions from the pitch Pmin0 to pitch Pmin(i) which becomes greater than or equal to Pbase1. Thus, the boundary on the outer side of the pitch Pmin(i) is assigned with the node of base0 or more.

ST14: Furthermore, the nodes of base1 or more are assigned to regions from the pitch Pmin(i+1) to the pitch Pmin(j) which becomes greater than or equal to Pbase2. Thus, the boundary on the outer side of the pitch Pmin(j) is assigned with nodes of base1 or more.

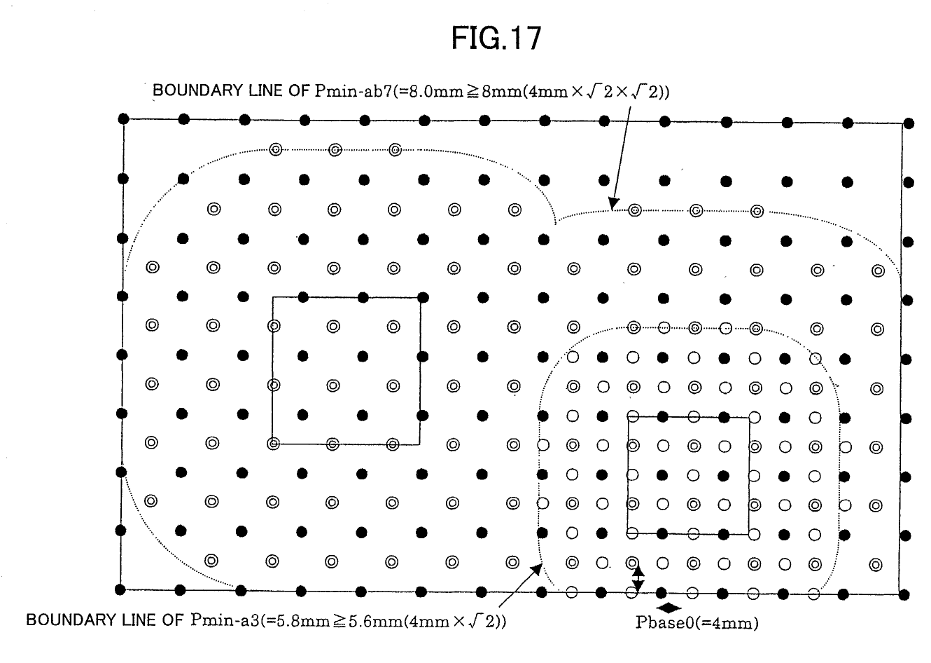

ST15: Similarly thereafter, the nodes of base2 or more are assigned to regions from the Pmin(j+1) to the pitch Pmin(k) which becomes greater than or equal to Pbase3. This procedure continues until all the regions are assigned with the nodes. FIG. 17 is a diagram explaining the assignment of nodes. In FIG,17, ○ indicate the nodes of base0, ⊚ indicate the nodes of base1, and ● indicate the nodes of base2.

Therefore, according to this embodiment, when forming the mesh model 9, the sectioning pitch P0 of the element 1, that is, the location where the wave source is connected, is calculated as a function of tr and tf of the wave source, and the sectioning pitch P1 is set at a location as this location moves further away from the wave source to a value less than or equal to a value which is calculated by a function of the sectioning pitch P0, the area S0 of the location where the wave source is connected, and the area S1 to the location moved further away from the wave source. In other words, the sectioning pitch is determined like wave patterns from the wave source. In this case, P0 is obtained from a formula P0[mm]=K1×C[mm/ns]×tr(or tf if tf<tr) [ns]÷√∈r. Here, C denotes the speed of light which is 300 mm/ns, and ∈r denotes the relative permittivity of a dielectric between the power supply layer 2 and the ground layer 3. Preferably, K1 is 1/π or less. Furthermore, the above function is preferably set to P1=√(P0²+K2×(√S1−√S0)). Furthermore, assuming that the system of units of P1, P0, S1 and S0 are mm and mm², K2 is desirably greater than or equal to 0 and less than or equal to 0.5. If an area from a certain area to a location separated by a certain distance from the certain area is regarded as a next new area, it is also possible to successively process the above area according to a formula Pn=√(Pn−1²+K2×(√Sn−√Sn−1)).

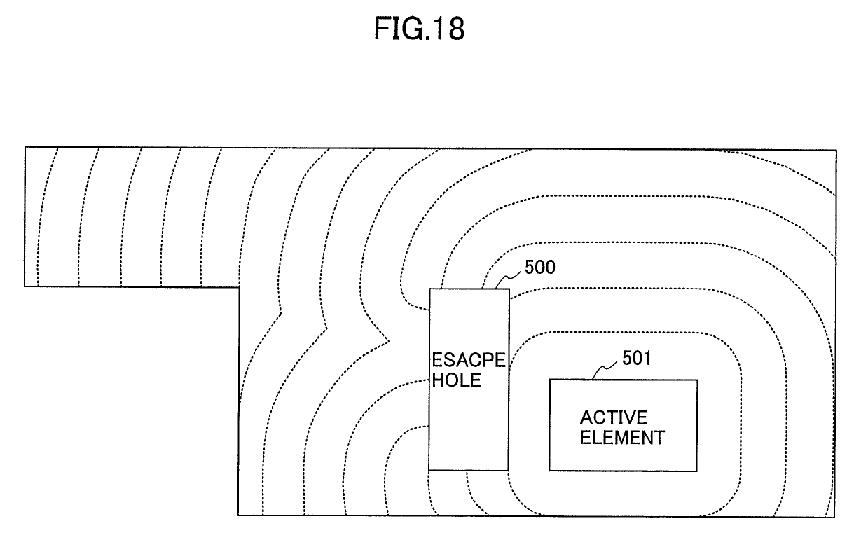

As a method of processing a special shape, a wraparound process will be described in conjunction with FIG. 18. FIG. 18 shows a case where an escape hole 500 and an active element 501 exist. Even in the case of such a shape where the wraparound is generated, the sectioning pitch of the mesh model 9 can be optimally determined by accurately transferring the wave pattern from the wave source, according to this embodiment.

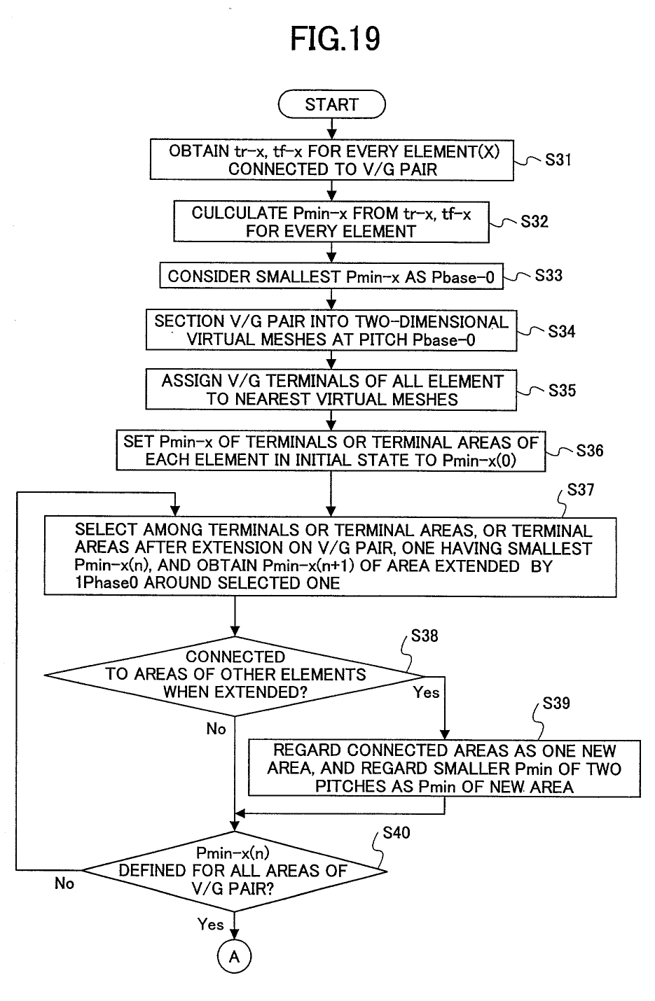

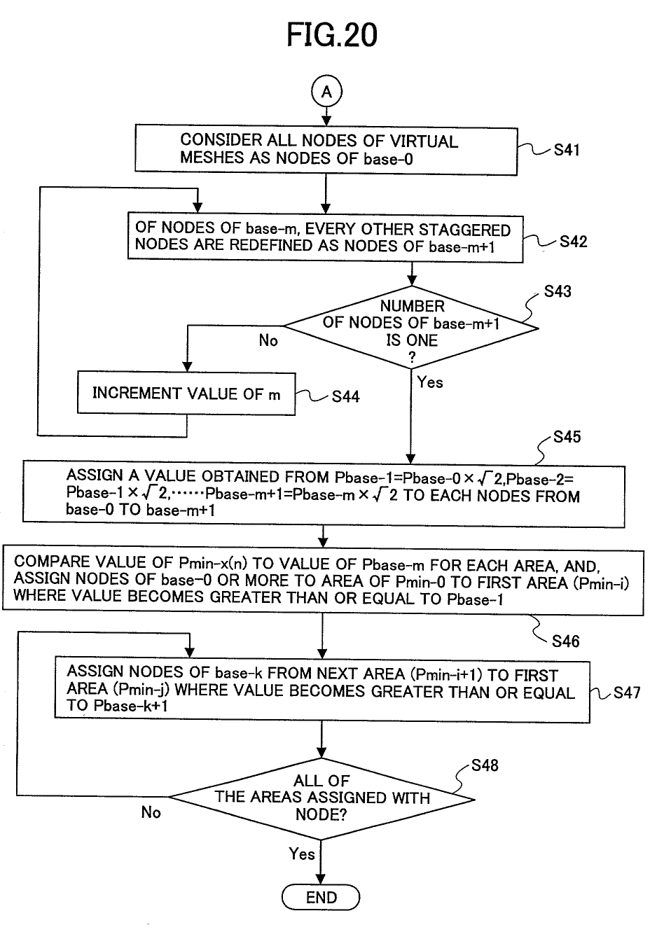

FIGS.19 and 20 are flow charts explaining the process executed by the CPU 201 for forming the mesh model 9 according to the procedures ST1 through ST15.

Referring to FIG. 19, in step S31, tr-x and tf-x are obtained for every active element x connected to the V/G pair. In step S32, a pitch Pmin-x is calculated from tr-x and tf-x for every element x, and in step S33, a smallest pitch Pmin-x is considered as Pbase-0. In step S34, the V/G pair is sectioned into two-dimensional virtual meshes at the pitch Pbase-0. In step S35, V/G terminals of all active elements x are assigned to the nearest virtual meshes. As a result, in a case where there are plural terminals for one element x and there are plural mesh points to which the terminals are assigned, the V/G terminal is assigned in the form of an area. In step S36, the pitch Pmin-x of plural terminals or terminal areas of each element x in the initial state is set to Pmin-x(0).

In step S37, of the plural terminals or terminal areas, or terminal areas after extension on the V/G pair, the one having the smallest pitch Pmin-(n) is selected, and the pitch Pmin-x(n+1) of the area extended by 1Pbase0 around the selected one is obtained, and at the same time, areas having the same pitch Pmin are processed. Here, n≧0. In step S38, a decision is made as to whether the area connects to areas of other elements when extended, and if the decision result is YES, the process proceeds to step S39 which regards the two connected areas as one new area, and regards the smaller of the two pitches Pmin as the pitch Pmin of this new area. After step S39, or, if the decision result in step S38 is NO, the process proceeds to step S40 which decides whether the pitch Pmin-x(n) is defined for all areas of the V/G pair, and if the decision result is NO, the process returns to step S37.

If the decision result in step S40 is YES, the process proceeds to step S41 shown in FIG. 20. In step S41, all nodes of the virtual meshes obtained in step S34 are considered as nodes of base-0. In step S42, of the nodes of base-m, every other staggered nodes are redefined as nodes of base-m+1. Here, m≧0. In step S43, a decision is made as to whether the number of nodes of base-m+1 is one or not, and if the decision result is NO, the process proceeds to step S44 in which the value of m is incremented by 1, and then the process returns to step S42.

On the other hand, if the decision result of step S43 is YES, the process proceeds to step S45 in which each of the nodes from base-0 to base-m+1 is assigned with a value obtained from Pbase-1=Pbase-0×√2, Pbase-2=Pbase-1×√2, . . . , Pbase-m+1=Pbase-m×√2. In step S46, the value of pitch Pmin-x(n) for each area defined in FIG. 19 is compared with the value of Pbase-m, and the nodes of base-0 or more are assigned from the area of the pitch Pmin-0 to a first area (pitch Pmin-i) where the value becomes greater than or equal to Pbase-1. Furthermore, in step S47, the nodes of base-k or more are assigned from the next area (pitch Pmin-i+1) to a first area (pitch Pmin-j) where the value becomes greater than or equal to Pbase-k+1. Here, k≧1 . In step S48, a decision is made as to whether all of the areas are assigned with a node, and if the decision result is NO, the process returns to step S47. On the other hand, if the decision result in step S48 is YES, the process ends and the mesh model 9 is output as in FIG. 5, and it is further decided whether the mesh model 9 is completed or not.

Further, the present invention is not limited to these embodiments, and variations and modifications may be made without departing from the scope of the present invention.

What is claimed is:

1. A model analyzing method for analyzing power supply noise of a circuit model, comprising the steps of:
forming, on the basis of AC characteristics, a feedthrough current model for simulation using, as a base model, a CMOS structure having one or more stages using a non-linear element; and
analyzing the power supply noise based on at least said feedthrough current model.

2. The model analyzing method as claimed in claim 1, further comprising the step of:
determining the AC characteristics by device parameters of the CMOS and a passive element added in a vicinity of a device.

3. The model analyzing method as claimed in claim 2, further comprising the steps of:
inputting the AC characteristics and the power supply voltage; and
automatically detecting coefficients of a suitable calculation formula with respect to the power supply voltage from a database, and automatically determining the device parameters satisfying the AC characteristics.

4. A model analyzing method for analyzing power supply noise of a circuit model, comprising the steps of:
forming, on the basis of DC characteristics and AC characteristics, a driver model for simulation using, as a base model, a CMOS structure having one or more stages using a non-linear element; and
analyzing the power supply noise based on at least said driver model.

5. The model analyzing method as claimed in claim 4, further comprising the step of:
determining at least one of said DC characteristics and said AC characteristics by controlling device parameters of the CMOS.

6. The model analyzing method as claimed in claim 5, wherein each parameter for determining said DC characteristics and said AC characteristics is determined based on an ON-resistance of an IBIS model, and a rise time and a fall time of a current waveform.

7. The model analyzing method as claimed in claim 6, further comprising the step of:
determining characteristics of said driver model based on data related to DC characteristics of said IBIS model, data related to AC characteristics of said IBIS model, and data related to the power supply voltage.

8. The model analyzing method as claimed in claim 6, further comprising the step of:
automatically retrieving data necessary for forming said driver model from said IBIS model, and using said data as an initial condition for forming said driver model.

9. A model analyzing method for analyzing power supply noise of a circuit model, comprising the steps of:
forming a mesh model for simulation by calculating a sectioning pitch P0 of a location where an element constituting a wave source is connected, as a function of a rise time tr and a fall time tf of a waveform from said wave source, and setting a sectioning pitch P1 at a location as this location moves further away from said wave source to a value less than or equal to a value that is calculated by a function of the sectioning pitch P0, an area S0 of said location where said wave source is connected, and an area S1 to the location moved further away from said wave source; and
analyzing said power supply noise based on at least said mesh model.

10. The model analyzing method as claimed in claim 9, wherein said sectioning pitch P0 is expressed by a formula P0=K1×C×tr(or tf if tf<tr)÷√∈r, where C denotes a speed of light, ∈r denotes a relative permittivity of a dielectric between a power supply layer and a ground layer, and K1 is 1/π or less.

11. The model analyzing method as claimed in claim 9, wherein said pitch P1 is expressed by P1=√(P0²+K2×(√S1−√S0)) if K2 is greater than or equal to 0 and less than or equal to 0.5.

12. The model analyzing method as claimed in claim 9, further comprising the step of:
regarding an area from a location separated by a certain distance from the certain area as a next new area, and successively processing said new area based on a formula Pn=√(Pn−1²+K2×(√Sn−√Sn−1)).

13. A model analyzing method for analyzing a power supply noise of a current model, comprising the steps of:
forming, on the basis of AC characteristics, a feedthrough current model for simulation using, as a base model, a CMOS structure having one or more stages using a non-linear element;
forming, on the basis of DC characteristics and AC characteristics, a driver model for simulation using, as a base model, a CMOS structure having one or more stages using a non-linear element;
forming a mesh model for simulation; and
arranging said feedthrough current model and said driver model in said mesh model and analyzing said power supply noise.

14. The model analyzing method as claimed in claim 13, wherein said step of forming said mesh model calculates a sectioning pitch P0 of a location where an element constituting a wave source is connected, as a function of a rise time tr and a fall time tf of a waveform from said wave source, and sets a sectioning pitch P1 at a location as this location moves further away from said wave source to a value less than or equal to a value which is calculated by a function of the sectioning pitch P0, an area S0 of said location where said wave source is connected, and an area S1 to the location moved further away from said wave source, so as to form said mesh model.

15. A computer-readable storage medium which stores a computer program for causing a computer to carry out a model analyzing process for analyzing power supply noise of a circuit model, said computer program comprising:
a procedure which causes the computer to form, on the basis of AC characteristics, a feedthrough current model for simulation using, as a base model, a CMOS structure having one or more stages using a non-linear element; and
a procedure which causes the computer to analyze the power supply noise based on at least said feedthrough current model.

16. A computer-readable storage medium which stores a computer program for causing a computer to carry out a model analyzing process for analyzing power supply noise of a circuit model, said computer program comprising:
a procedure which causes the computer to form, on the basis of DC characteristics and AC characteristics, a driver model for simulation using, as a base model, a CMOS structure having one or more stages using a non-linear element; and
a procedure which causes the computer to analyze the power supply noise based on at least said driver model.

17. A model analyzing apparatus for analyzing power supply noise of a circuit model, comprising:
means for forming, on the basis of AC characteristics, a feedthrough current model for simulation using, as a base model, a CMOS structure having one or more stages using a non-linear element;
means for forming, on the basis of DC characteristics and AC characteristics, a driver model for simulation using, as a base model, a CMOS structure having one or more stages using a non-linear element;
means for forming a mesh model for simulation; and
means for arranging said feedthrough current model and said driver model in said mesh model and analyzing said power supply noise.

18. The model analyzing apparatus as claimed in claim 17, wherein said means for forming said mesh model calculates a sectioning pitch P0 of a location where an element constituting a wave source is connected, as a function of a rise time tr and a fall time tf of a waveform from said wave source, and sets a sectioning pitch P1 at a location as this location moves further away from said wave source to a value less than or equal to a value that is calculated by a function of the sectioning pitch P0, an area S0 of said location where said wave source is connected, and an area S1 to the location moved further away from said wave source, so as to form said mesh model.
